(19) United States
(12) Patent Application Publication
(10) Pub. No.: US 2026/0237588 A1
(43) Pub. Date: Aug. 13, 2026

(54) Devices and Methods for Creation of Exotic Vacuum Objects

(71) Applicants: Russell Denning Davis, Titusville, FL (US); Douglas Willard Lindstrom, St. Albert, CA (US)

(72) Inventors: Russell Denning Davis, Titusville, FL (US); Douglas Willard Lindstrom, St. Albert, CA (US)

(73) Assignee: Magnetic Miles, LLC, Stuart, FL (US)

(21) Appl. No.: 18/831,651

(22) Filed: Dec. 5, 2024

Related U.S. Application Data
(60) Provisional application No. 63/629,992, filed on Dec. 18, 2023.

(51) Int. Cl. H01J 27/02; H01J 27/08; H01J 27/24

(52) U.S. Cl. CPC H01J 27/026; H01J 27/08; H01J 27/24

(57) ABSTRACT

A method with exemplars is presented for producing a large number of miniature plasmoid entities labeled exotic vacuum objects (EVOs). EVOs possess ball-lightning-like attributes on a micro or nano scale. Many researchers have shown EVOs to interact with material matter in specialized and unusual ways, including mediating and affecting nuclear processes. Prior art teaches various means to create a single EVO at a time, or small numbers of them. Herein a means is described to produce a large quantity of EVOs at one time within a volume of fluid medium.

### CROSS-REFERENCE TO RELATED APPLICATIONS

This patent application claims the benefit of U.S. Provisional Ser. No. 63/629,992 filed Dec. 18, 2023.

### BACKGROUND

During the late twentieth century, while experimenting with electric arc discharges, a researcher in the United States, Kenneth Shoulders, encountered unanticipated micro-entities comprising large numbers of highly dense charged and organized particles (electrons, and, or positive ions). These charged entities were initially named, Electrum Validum (EV) by Shoulders, and have been variously labeled as micro plasmoids, micro ball-lightning, or exotic vacuum objects (EVOs) by other researchers. The behavior of EVOs was studied by Shoulders and others, but in more recent years, EVOs have been implicated in certain nuclear processes, such as low energy nuclear reactions (LENR), and low energy element transmutation. Consequently, EVOs are of interest, for example, in exploring ways to develop alternate energy sources, such as by LENR.

Shoulders identified and patented electric discharge means of producing EVOs (U.S. Pat. Nos. 5,018,180; 5,054,046; 5,054,047; 5,123,039; 5,148,461; 5,153,901). In the aforementioned prior art, Shoulders teaches a means to create and guide an EVO by employing an electrode system comprising a flat anode and a pointed cathode, with a solid dielectric material interposed between these electrodes. This electrode system is maintained in a vacuum or gaseous environment. A high voltage negative pulse is supplied to the cathode (on the order of −10 kV) resulting in the creation of an EVO at the pointed cathode tip. Typically, an EVO may be expected to be formed for each pulse applied to the cathode. This limits the number of EVOs that can be created per unit time to the allowable pulse repetition rate (a serial process).

In the case of previously disclosed electric discharge methods, and, or cavitation methods alone, a limited quantity of EVOs is produced. It is the purpose of the present invention to establish the means for producing large amounts of EVOs.

Other researchers have suggested a theoretical basis, or alternatively identified empirical evidence, for the existence of EVOs and their behavior. A brief list of references to some of this work appears as follows:
Winston Bostick, “Experimental Study of Plasmoids,” Phys. Rev. 106, 404—Published May 1, 1957; Erratum Phys. Rev. 107, 1736 (1957)
Takaaki Matsumoto, “Extraordinary Traces Produced during Pulsed Discharges in Water,” Bulletin of the Faculty of Engineering, Hokkaido University, No. 175 (1995)
Takaaki Matsumoto, “Steps to the Discovery of Electro-Nuclear Collapse: Collected Papers (1989-1999) Paperback—Jul. 23, 2022” https://www.amazon.com/Steps-Discovery-Electro-Nuclear-Collapse-Collected/dp/B0B6XS3M7D
Gennady Mesyats, “Proc. 17th Int. Sym. on Discharges and Electrical Insulation in Vacuum”, 720 (1996)
John Wheeler, “Geons,” Phys. Rev. 97, 2—Published Jan. 15, 1955

### BRIEF SUMMARY OF THE INVENTION

The present invention employs a liquid medium or electrolyte (typically water) which is preconditioned to contain a large number of microbubbles, and, or nanobubbles. A specialized submerged electric arc discharge of relatively lower power density may be utilized to invoke the precondition microbubbles, and, or nanobubbles (through electrolysis and the concomitant subsonic shockwave caused by the arc discharge). Alternatively, the microbubbles, and, or nanobubbles, can be created by cavitation (such as by coupling ultrasonic acoustic energy into the liquid via a piezo transducer, with motor-driven rotating blades, or using motor-driven vibrating plates). Four types of microbubbles, and, or nanobubbles, generating mechanisms are identified as follows—thermally generated bubbles, electrolysis bubbles, cavitation bubbles generated by various means, venturi generated bubbles. There are also other mechanisms for generating microbubbles, and, or nanobubbles, that are not discussed here.

The microbubbles, and, or nanobubbles, containing liquid is then subjected to a high power density shockwave that can be produced by a separate submerged electric arc discharge of relatively high power density, for example, or alternatively by a short powerful laser pulse. Exploding wires and combustion processes have also produced shockwaves of the required power density. A salient aspect of the EVO-producing shockwave is that it must be generated by sufficient power to cause the shockwave to have supersonic rather than subsonic transport velocity, but also energetic enough to ionize the medium as it propagates. When this supersonic shockwave, often termed ionizing wave, moves through the liquid and bubble mixture, it interacts with individual microbubbles, and, or nanobubbles, to produce dynamic clusters of charge called EVOs.

The present invention overcomes the EVO quantity limitation of Shoulders by invoking a parallel creation process in which multiple EVOs are generated simultaneously in a liquid environment. This can result in large numbers of EVOs per cubic centimeter volume of liquid media being produced at one time.

Below is a lexicon of terms used in this disclosure to support the meaning of the specification and to clarify interpretation of the appended claims.

### Definitions

air inlet pipe—a tube of metal, plastic, or other material used to convey the local ambient atmosphere, or some other gas, or gas mixture; in the context of the present invention, and with reference to FIGS. 12 and 13, an air inlet pipe enables access to, and the supply of, gas-phase substance to a venturi
aqueous salt solution—one or more chemical ionic-compounds dissolved in water (liquid H₂O, D₂O, or mixture of both); in the context of the present invention, and with reference to each of the figures and identified as item 23 and labeled “water,” an aqueous salt solution may be a chosen liquid substance that is placed, and retained, inside a containment vessel and used as a medium to impose creation of exotic vacuum objects
atmosphere—typically the envelope of gases surrounding the earth at local ambient temperature, pressure, and humidity, but may also be a single elemental gas, mixture of elemental gasses, a gas-phase chemical compound, or any mixture of elemental gas or gases with chemical-compounds that are in the gas phase; in the context of the present invention, and with reference to each of the figures, atmosphere is identified as item 21 labeled, “air”
beam waist—beam waist of a laser beam is the position along the direction of propagation where the beam diameter has a minimum; in the context of the present invention, and with reference to FIGS. 1,7,8,10,12, and 14, beam waist is identified as item 13, labeled, “focused laser beam” wherein said beam waste is sufficiently small such that the energy and power density is great enough to create an ionizing wave having supersonic transport velocity
bubbles—small vapor-filled cavities in a liquid; in the context of the present invention, and in reference to each of the figures, bubbles are formed in the liquid identified as item 23, either by means of electrolysis incurred by electric current imposed through electrodes submerged in said liquid, or from compressed air or gas emitted by a micro orifice nozzle also as submerged in said liquid, or by cavitation, or by means of a venturi microbubble generator
cable—electrical conductor, or set of multiple conductors, used to convey electrical power, and or electrical communication signals; in the context of the present invention, and with reference to FIGS. 1,2 and 14, cable, identified as item 5, provides the electrical power of the requisite pulsed or alternating current frequency to a piezo transducer such that ultrasonic sound waves are produced inside a containment vessel; additionally, cable is identified as item 6, in reference to FIGS. 10 and 11, and is used to provide electrical power and or electrical signals to an electrically controlled valve
cavitation—a phenomenon wherein the static pressure of a liquid decreases below the liquid's vapor pressure resulting in creation of small vapor-filled cavities in the liquid that are referred to as cavitation bubbles or cavitation voids; in the context of the present invention, cavitation bubbles may be established by one or more means, but are invoked as seed bubbles contained in the liquid identified as item 23 in each of the figures and which are to be converted into exotic vacuum objects
cavitation bubbles—see “cavitation” above
coherent matter—a group of collective particles whose individual motion is in phase with all other said particles, and attributes of the coherent matter can be described by a coherent matter wave-function; in the context of the present invention, an exotic vacuum object is a form of coherent matter
compressed air—a portion of atmosphere content established and contained through any means that is maintained at higher pressure than ambient atmospheric pressure; in the context of the present invention, and in reference to FIGS. 10 and 11, compressed air is held in a type of containment vessel identified as item 3 and conveyed by a pipe or hose to a micro orifice nozzle to produce bubbles in a liquid substance wherein said nozzle is submerged
compressed gas—a gas or mixture of gases different from atmosphere content, established and contained through any means, but maintained at higher pressure than ambient atmospheric pressure; in the context of the present invention, and in reference to FIGS. 10 and 11, compressed gas is held in a type of containment vessel identified as item 3 and conveyed by a pipe or hose to a micro orifice nozzle to produce bubbles in a liquid substance wherein said nozzle is submerged
containment vessel—a physical structure establishing a volume capable of holding a substance confined within said volume; in the context of the present invention, and in reference to each of the figures, containment vessel is identified as item 1 which holds a liquid substance that is the medium in which exotic vacuum objects are created, but also in reference to specific FIGS. 10 and 11 where item 3 designates both a containment vessel and its contents comprising compressed air or compressed gas
drain port valve—a device mounted in, or attached to, a containment vessel wherein said device has an aperture that can be opened to allow a substance to be removed from the containment vessel, or closed to retain said substance inside the containment vessel; in the context of the present invention, and in reference to FIG. 14, drain port valve is identified as item 4 which enables addition, retention, or removal of substance designated as item 21, and or addition or removal or retention of substance designated as item 23
electric arc discharge—see “electrical arc discharge” below
electrical arc discharge—the dielectric breakdown of an electrical insulating substance when subjected to a high enough voltage that it suddenly becomes a conductor and electric current flows through it; in the context of the present invention, and in reference to FIGS. 2,3,4,5,6,9,11, and 13, electrical arc discharge is produced by electrodes submerged in liquid (item 23) that is able to produce an ionizing wave in said liquid
electrically controlled valve—a valve that can be opened or closed by means of applying electrical power or electrical signals; in the context of the present invention, and in reference to FIGS. 10 and 11, electrically controlled valve is identified as item 4 and is used to start, stop, throttle, or otherwise modulate the flow of air or gas to and or through a micro orifice nozzle
electrode—an electrical conductor used to convey electrical power or electrical signals to a substance either by direct physical contact with said substance, or through an electrical arc discharge; in the context of the present invention, electrodes are used to impose physical location of electrical arc discharge, and or electrolysis, within the volume of liquid identified as item 23, as shown in FIGS. 2,3,4,5,6,9,11, and 13
electrode insulation—a substance that is a non-conductor of electricity which is affixed to an electrode to provide galvanic isolation of the electrode from said electrode's surrounding environment; in the context of the present invention, electrode insulation prevents contact of electrode surface with the liquid substance identified as item 23 in FIGS. 2,3,4,5,6,9,11, and 13, except at electrode surface locations where said insulation is not present
electrolysis—the splitting of chemical bonds of a liquid substance with the application of electrical voltage (which produces an electrical current) as introduced through electrodes in said liquid; in the context of the present invention, electrolysis may be employed to create bubbles within the volume of liquid identified as item 23 in FIGS. 4,5, and 6
electrolysis bubbles—a collection of individual separate volumes of a gas or gas mixture that emanate from within a liquid substance during electrolysis; in the context of the present invention, electrolysis may be employed to create bubbles within the volume of liquid identified as item 23 in FIGS. 4,5, and 6
exotic vacuum object—(singular abbreviation, EVO; plural abbreviation, EVOs) an exotic vacuum object is a stable plasmoid aggregation of electrons, and or ions. This aggregation of charged entities, typically electrons, collect into a large (on the quantum scale) dense structure. Such a structure can typically contain 10¹¹ electrons or more and have a diameter of 0.1 micron, but also be stable to a diameter of 0.1 millimeter for long periods of time (hours or more). The most common theory for the nature and composition of EVOs is that they are microscopic toroidal vortices of plasma with internal positive ions and exterior electrons. EVOs have been associated as mediating and causal agents in low energy nuclear reactions (LENR). In the context of the present invention, the intended function of the devices and methods described herein is to create large numbers of EVOs within a liquid medium (item 23 in the figures)
focused laser beam—a laser beam modified by optical devices such as a collimator and or a lens or multiple lenses so as to reduce the beam waist to a smaller size than that of the raw laser beam; in the context of the present invention, focused laser beam is identified as item 13 in reference to FIGS. 1,7,8,10,12, and 14, wherein the function of said focused laser beam is to couple sufficient energy and power density into the volume of liquid, identified as item 23, so as to cause an ionizing wave within the volume of said liquid
focused laser beam pulse—a raw laser beam modified by focusing optics to achieve a smaller beam waist, but with laser energy that is in the form of a transient pulse, rather than continuous; in the context of the present invention, focused laser beam pulse refers to the transient, temporal, characteristic of a focused laser beam that enables very high power density, owing to the short time interval in which the laser energy is present and the small volume where it is directed
focusing optics—device or devices used to modify the spatial characteristics of electromagnetic radiation; typically when applied to a laser beam, it's intended to reduce the beam waist diameter; in the context of the present invention, focusing optics, identified as item 15 with reference to FIGS. 1,7,8,10,12, and 14, reduces the beam waste in order to maximize the power density at the focused location within the volume of liquid (said liquid is identified as item 23 in the figures)
gas mixture—a volume containing one or more different gases each comprising a single element, and or chemical-compounds that are in the gas phase; in the context of the present invention, a gas mixture may be the content of compressed air or compressed gas or contained in bubbles within the volume of liquid that is identified as item 23 in the figures
hermetically seal—a coating or substance adhered to an electrode such that no gas or liquid substance may physically contact the electrode in the location where said coating is applied; in the context of the present invention, electrode insulation is hermetically sealed to the electrode wherein said insulation may be made of glass, ceramic, or some other substance, and which prevents electrode contact with liquid (identified as item 23 in the figures) along the length of submerged electrodes where hermetically sealed insulation is present
high voltage cable—a type of cable able to convey high electrical potential without incurring dielectric breakdown of its insulating jacket or coating; depending on the application, the potential may be 50 volts or more; in the context of the present invention, high voltage cable is identified as items 19 and 25 in FIGS. 2,3,4,5,6,9, and 11, and also identified as items 37 and 39 in FIGS. 4, and 13
high voltage pulse—an electrical potential of 50 volts or greater and having temporary duration; in the context of the present invention, a high voltage pulse may be applied within the volume of liquid (item 23 in the figures) to produce an ionizing wave within said volume of liquid
high voltage pulse controller—a mechanical or electrical device or system used to achieve application of an electrical potential of 50 volts or greater for temporary duration (i.e. not continuous); in the context of the present invention, high voltage pulse controller is identified as item 27 in FIGS. 2,3,4,6,9, and 11, also as item 28 in FIG. 5, and also as item 41 in FIGS. 4, and 13, wherein said high voltage pulse controller provides the electrical potential and electrical power that is supplied through electrodes, as submerged in liquid (item 23), to create an ionizing wave in said liquid
high voltage pulse discharge—an electrical arc discharge of temporary duration resulting from a transient electrical potential of 50 volts or greater; in the context of the present invention, high voltage pulse discharge occurs between electrodes (items 11 and 13 in FIGS. 2,3,4,5,6,9,11, and also items 29 and 31 in FIGS. 4 and 13) which are submerged in liquid (item 23 in the figures) to create an ionizing wave within said liquid
inlet port valve—a device mounted in, or attached to, a containment vessel wherein said device has an aperture that can be opened to allow a substance to enter or exit the containment vessel, or closed to retain said substance inside the containment vessel, and or prevent further addition of any substance to the containment vessel; in the context of the present invention, and in reference to FIG. 14, inlet port valve is identified as item 2 which enables insertion, retention, or removal of substances designated as air or water (items 21 and 23)
interface surface—a boundary between different substances; in the context of the present invention, interface surface is identified as water surface (item 9 in each of the figures)
intense—large in magnitude, typically with respect to energy density and or power density; in the context of the present invention, energy and or power density capable of producing a plasma and or an ionizing wave
ionization—process by which an atom or a molecule obtains a positive or negative charge by losing or gaining electrons; in the context of the present invention, ionization is caused by laser beam, or electrical arc discharge, and or a concomitant ionizing wave produced by a laser beam or electrical arc discharge
ionizing wave—a shockwave having sufficient energy to cause ionization in the substance through which it propagates; in the context of the present invention, an ionizing wave is introduced within the liquid, identified as item 23 in the figures, to convert extant seed bubble into exotic vacuum objects
laser—a device that achieves light amplification which is phase-coherent by means of stimulated emission of radiation; said radiation (light) can be of any particular wavelength ranging from infrared through visible to ultraviolet; in the context of the present invention, laser is identified as item 19 in FIGS. 1,7,8,10,12, and 14, and is a source of intense electromagnetic radiation which gets conveyed into the volume of a liquid (item 23 in the figures) to create an ionizing wave within said liquid
laser beam—the electromagnetic radiation, its path, and the volume occupied by the emitted radiation coming from a laser (also see “raw laser beam” below); in the context of the present invention, the laser beam from a laser is identified as item 17 in FIGS. 1,7,8,10,12, and 14, which is then directed into focusing optics (item 15 in said figures) to reduce the beam waist size
laser pulse—a temporal, transient, electromagnetic radiation emitted from a laser that is briefly turned on then off; in the context of the present invention, a laser pulse is obtained from laser source, identified as item 19 in FIGS. 1,7,8,10,12, and 14, which is directed into liquid (item 23 in said figures) through focusing optics (item 15 in said figures) to create an ionizing wave within the volume of said liquid
low voltage electrolysis-causing pulse—an electrical potential of less than 50 volts and having temporary duration; in the context of the present invention, a low voltage electrolysis-causing pulse may be applied within the volume of liquid (item 23 in the figures) to produce bubbles within said volume of liquid, as gas or gas mixture, liberated through the electro-chemical process of electrolysis
low voltage pulse controller—a mechanical or electrical device or system used to achieve application of an electrical potential of less than 50 volts having temporary duration (i.e. not continuous); in the context of the present invention, low voltage pulse controller is identified as item 28 in FIG. 5, also as item 42 in FIG. 6, and is the source of electrical energy applied within a liquid (item 23 in the figures), by means of electrodes submerged in said liquid to invoke electrolysis and concomitant creation of electrolysis bubbles
matter wave—within the topical area of physics there is the concept of wave-particle duality by which constituent particles that are the building blocks of matter and or energy possess both corpuscular (particle) and wave behavior. The terminology, “matter wave” refers to the wave aspect of matter, and a matter wave can be described mathematically; in the context of the present invention, an exotic vacuum object possesses matter wave attributes
microbubble—a gas or vapor volume, submerged in a liquid substance, wherein the said gas or vapor volume's maximum dimension, or diameter, is in the range of one micron up to one millimeter; in the context of the present invention, microbubbles within a liquid (item 23 in the figures) may be subjected to an ionizing wave within said liquid to create exotic vacuum objects
micro-orifice—aperture having a diameter in the range of one micron to one millimeter; also see “micro orifice nozzle” below
micro orifice nozzle—a nozzle having an aperture of micro-orifice size; in the context of the present invention, a micro orifice nozzle that is submerged in a liquid (item 23 in the figures) is used to create microbubbles within said liquid when compressed air or compressed gas is caused to flow out of said nozzle
micro-size—object whose maximum dimension is in the range of one micron to one millimeter; in the context of the present invention, micro-size refers to the dimension of a microbubble; see “microbubble” above
motor—engine or device powered by electricity, combustion of fuel, or compressed gas powered, that establishes a rotating or reciprocating shaft that can do work; in the context of the present invention, motor is identified as item 3 in FIGS. 7,8, and 9, and it imposes the mechanical motion, conveyed by a shaft, of a plate or propeller that is submerged in liquid (item 23 in the figures) so as to produce cavitation bubbles within said liquid
nanobubble—a gas or vapor volume, submerged in a liquid substance, wherein the said gas or vapor volume's maximum dimension, or diameter, is in the range of one nanometer up to one micron; in the context of the present invention, nanobubbles within a liquid (item 23 in the figures) may be subjected to an ionizing wave within said liquid to create exotic vacuum objects
optical Window—optically transparent plate or lens that is designed to maximize transmission in a specified electromagnetic wavelength range, while minimizing reflection and absorption; in the context of the present invention, optical window is identified as item 11 in FIGS. 1,7,8,10,12, and 14, and is the place in the structure of a containment vessel (identified as item 1 in the figures) through which a laser beam is directed into the-interior of said containment vessel to cause an ionizing wave within a liquid (item 23 in said figures)
piezoelectric effect—the generation of mechanical stress in a material when an electric field is applied to said material; also see “piezo transducer” below
piezo transducer—a device that employs the piezoelectric effect to convert electrical energy or signals into acoustic or sound wave energy; in the context of the present invention, a piezo transducer, identified as item 3 in FIGS. 1,2, and 14, is affixed to a containment vessel to impart ultrasonic sound waves into a liquid (item 23 in said figures) to produce cavitation bubbles
piezo transducer controller—an electronic device or system that provides the electrical signals needed to drive (or electrically power) a piezo transducer; in the context of the present invention, piezo transducer controller is identified as item 7 in FIGS. 1,2, and 14, and provides the electrical power and or electrical signals to a piezo transducer (item 3 in said figures)
plasma—an ionized gas consisting of positive ions and free electrons in equal (or nearly equal) proportions; in the context of the present invention, a short intense laser beam pulse creates a plasma at the beam focus (item 13 in FIGS. 1,7,8,10,12, and 14) within a liquid (item 23 in said figures) which rapidly expands to produce an ionizing wave
pressure containment vessel—a physical structure establishing a volume capable of holding a substance, or substances, in liquid, and or gas, phase but confined within said volume at pressures equal to, or different than, atmospheric pressure; in the context of the present invention, and in reference to FIG. 14, pressure containment vessel is identified as item 1 which holds a liquid substance, and or air, or other gases, or a gas mixture, wherein said liquid substance (identified as item 23 in FIG. 14) is the medium in which exotic vacuum objects are formed
propeller—a device with blades attached to a central hub that spins around the hub center; blades may or may not have pitch (i.e. be at some predetermined fixed angle about their radial axis from the hub); in the context of the present invention, propeller is identified as item 7 in FIGS. 8 and 9 and rotates at sufficient speed to create cavitation bubbles within the liquid (item 23 in said figures) in which it's submerged
pulsed laser source—a laser device capable of producing one or more laser pulses, which are short durations of laser beam energy; see “laser beam” and “laser pulse” above
pump—an electrical or mechanical device using suction or pressure to raise or move liquids, compress gases, or force gases through a nozzle; in the context of the present invention, pump is identified as item 7 in FIGS. 12 and 13, and is used to force the flow of liquid (item 23 in said figures) through a venturi microbubble generator (item 8 in said figures)
raw laser beam—coherent electromagnetic radiation from a laser that has not been altered in any way by another device or system after its emission from the laser; see “laser beam” above
reciprocating shaft—a solid material (substance), typically longer than its width (for example, long and narrow), used to convey mechanical energy through oscillating motion along its long-axis; in the context of the present invention, reciprocating shaft is identified as item 5 in FIG. 7, to which a plate (FIG. 7, item 7) is attached and submerged in liquid (item 23 in FIG. 7) wherein said plate is caused to vibrate at a rate sufficient to create cavitation bubbles within said liquid
rotating shaft—a solid material (substance), typically longer than its width (for example, long and narrow), used to convey mechanical energy through rotation about its long-axis; in the context of the present invention, rotating shaft is identified as item 5 in FIGS. 8 and 9, to which a propeller (item 7 in said figures) is attached and submerged in liquid (item 23 in FIG. 7) wherein said propeller is caused to rotate at a rate sufficient to create cavitation bubbles within said liquid
seed bubbles—cavitation bubbles, or any type of bubbles, that provide the initial entities which get converted into exotic vacuum objects by interaction with a shockwave or shockwaves, or ionizing wave; in the context of the present invention, bubbles are established by various means within a liquid (item 23 in the figures) and these bubbles (seed bubbles) are the precursor entities which are converted into exotic vacuum objects by an ionizing wave
shockwave—a compressional, or longitudinal, wave which propagates in a substance as caused by a transient powerful energy pulse that is applied to said substance; in the context of the present invention, a shockwave which is an ionizing wave is produced by various means within a liquid (item 23 in the figures) to interact with extant seed bubbles (also within said liquid) to create exotic vacuum objects
solid construction—fabricated from a solid-phase material-matter substance; in the context of the present invention, containment vessel (item 1 in the figures) is made of solid construction
substance—material matter in any of its forms, being one of, or a combination of, solid, liquid, gas, plasma, Bose-Einstein Condensate, Fermi-Dirac Condensate, or exotic vacuum object(s)
supersonic speed—magnitude of the velocity of an entity that is moving in a particular substance, wherein this magnitude is greater than that of the magnitude of velocity of sound wave propagation in said substance; in the context of the present invention, an ionizing wave is caused to propagate within the volume of liquid (item 23 in the figures) at supersonic speed
subsonic transport velocity—velocity of an entity that is moving in a particular substance wherein this velocity is less than the velocity of sound wave propagation in said substance; in the context of the present invention, a shockwave having subsonic transport velocity concomitant to electrolysis bubble creation may be produced by an electric arc discharge within a liquid (item 23 in FIGS. 3,4,5, and 6)
supersonic transport velocity—velocity of an entity that is moving in a particular substance wherein this velocity is greater than the velocity of sound wave propagation in said substance
thermally generated bubbles—creation of vapor filled volumes inside a liquid substance as established by adding sufficient energy to said liquid to cause a phase-change from liquid to gas
toroidal EVO—exotic vacuum object having a torus-shaped (doughnut-shaped) volume; in the context of the present invention, seed bubbles are converted into toroidal EVOs when subjected to an ionizing wave
ultrasonic—sound energy or waves the have a frequency typically above 20 kilohertz; in the context of the present invention, ultrasonic sound waves are created within a volume of liquid (item 23 in FIGS. 1,2, and 14) to produce cavitation bubbles within said volume of liquid
valve—a device for controlling the passage of fluid, gas, or a gas mixture through a pipe, duct, or container; said device can be controllable (opened or closed) by electrical or mechanical means; in the context of the present invention, an electrically controlled valve (item 4 in FIGS. 10 and 11) is used to start or stop the flow of compressed air or compressed gas through a micro orifice nozzle
valve pulse controller—an electronic device that sends electrical power, and or electrical signals to a valve to open or close the valve; in the context of the present invention, valve pulse controller is identified as item 8 in FIGS. 10 and 11 and is used to regulate the flow of compressed air or compressed gas by opening or closing a valve (item 4 in said figures)
venturi—a short tube with a tapering constriction in the middle that causes an increase in the velocity of flow of a fluid and a corresponding decrease in fluid pressure
venturi generated bubbles—bubbles created by a venturi submerged in a liquid substance
venturi microbubble generator—a device submerged in a liquid substance that creates microbubbles by means of the Venturi effect wherein air, or a gas, or gas mixture, is introduced into the said device's liquid flow by an air inlet pipe resulting in bubbles exiting the venturi nozzle; in the context of the present invention, venturi microbubble generator is identified as item 8 in FIGS. 12 and 13, and is used to create seed bubbles within a liquid (item 23 in said figures)
vibrating plate—oscillating mechanical motion of a rigid, or flexible, solid material (substance) which typically is in the shape of a flat circle, oval, or polygon (for example, rectangular) wherein the thickness of the plate is its smallest dimension; however, the plate may also possess some amount of curvature along one or more of its dimensions
water—typically the liquid phase substance comprising the chemical compound H₂0 or D₂O, or a mixture of both, with dissolved salts, such as a aqueous salt solution, or with other dissolved chemical elements or chemical compounds, or having suspended colloidal particles of solid substances, or without any dissolved or colloidally suspended solid substances, but also referring to any substance in liquid phase, whether H₂O, D₂O, or other chemical element or chemical compound that is a liquid either at room temperature, below room temperature, or above room temperature, and having dissolved substances or colloidally suspended particle substances, or not having dissolved substances or colloidally suspended particle substances; in the context of the present invention, and in reference to each of the figures, water is a broad all-inclusive term for the liquid substance identified as item 23 in which exotic vacuum objects are created
water inlet pipe—a tube of metal, plastic, or other material used to convey water or other liquid substance into a pump; in the context of the present invention, water inlet pipe (item 3 in FIGS. 12 and 13) conveys liquid (item 23 in said figures) to a pump (item 7 in said figures)
water outlet pipe—a tube of metal, plastic, or other material used to convey water or other liquid substance out of a pump; in the context of the present invention, water outlet pipe (item 5 in FIGS. 12 and 13) conveys liquid (item 23 in said figures) from a pump (item 7 in said figures) to a venturi microbubble generator (item 8 in said figures)

### BRIEF DESCRIPTION OF THE DRAWINGS

FIG. 1 is a schematic diagram that depicts one embodiment of the invention intended to produce numerous EVOs within in a liquid environment by subjecting acoustically created cavitation bubbles to ionization and shock-wave as produced by a laser pulse.

FIG. 2 is a schematic diagram that illustrates an alternate embodiment to produce numerous EVOs within in a liquid environment by subjecting acoustically created cavitation bubbles to ionization and shock-wave produced by a high-voltage pulse discharge.

FIG. 3 is a schematic diagram that illustrates an alternate embodiment to produce numerous EVOs within in a liquid environment by imposing a modest high-voltage discharge to form bubbles followed by ionization and shock-wave by means of a higher-voltage pulse discharge.

FIG. 4 is a schematic diagram that identifies an alternate embodiment to produce numerous EVOs within in a liquid environment by imposing a modest electric discharge to form bubbles using a first set of electrodes, followed by ionization and shock-wave by means of a high-voltage pulse discharge obtained from a second set of electrodes.

FIG. 5 is a schematic diagram that illustrates an alternate embodiment to produce numerous EVOs within in a liquid environment by imposing a low-voltage to form electrolysis bubbles followed by ionization and shock-wave by means of a high-voltage pulse discharge.

FIG. 6 is a schematic diagram that shows an alternate embodiment to produce numerous EVOs within in a liquid environment by imposing a low-voltage with a first set of electrodes to form bubbles followed by ionization and shock-wave by means of a high-voltage pulse discharge applied to a second set of electrodes.

FIG. 7 is a schematic diagram that depicts an embodiment of the invention intended to produce numerous EVOs within in a liquid environment by subjecting mechanically created cavitation bubbles, as caused by a vibrating submerged plate, to ionization and shock-wave produced by a laser pulse.

FIG. 8 is a schematic diagram that shows an embodiment of the invention intended to produce numerous EVOs within in a liquid environment by subjecting mechanically created cavitation bubbles, as caused by a rotating submerged propeller, to the ionization and shock-wave as produced by a laser pulse.

FIG. 9 is a schematic diagram that illustrates an embodiment of the invention intended to produce numerous EVOs within in a liquid environment by subjecting mechanically created cavitation bubbles, as caused by a rotating submerged propeller, to the ionization and shock-wave as produced by a high-voltage pulse.

FIG. 10 is a schematic diagram that shows an embodiment of the invention for producing numerous EVOs within in a liquid environment by subjecting bubbles from compressed air or gas, as emitted by a submerged micro-orifice, to the ionization and shock-wave as produced by a laser pulse.

FIG. 11 is a schematic diagram that depicts an embodiment of the invention for producing numerous EVOs within in a liquid environment by subjecting bubbles from compressed air or gas, as emitted by a submerged micro-orifice, to the ionization and shock-wave as produced by a high-voltage discharge.

FIG. 12 is a schematic diagram that shows an embodiment of the invention for producing numerous EVOs within in a liquid environment by subjecting bubbles from a submerged venturi microbubble generator to the ionization and shock-wave as produced by a laser pulse.

FIG. 13 is a schematic diagram that shows an embodiment of the invention for producing numerous EVOs within in a liquid environment by subjecting bubbles from a submerged venturi microbubble generator to the ionization and shock-wave as produced by a high-voltage discharge.

FIG. 14 is a schematic diagram that depicts an embodiment of the invention for producing numerous EVOs within a liquid environment that is in a sealed container such that the pressure inside the container may be maintained at a pressure which is different from atmospheric pressure. Acoustically created cavitation bubbles in the liquid are subjected to ionization and shock-wave as produced by a laser pulse.

### DETAILED DESCRIPTION OF THE INVENTION

The present invention relies on the creation of EVOs through the interaction of a shock wave with extant cavitation microbubbles, and, or nanobubbles, in a liquid medium. There are several possible physical means to establish the initial condition of a liquid substance containing microbubbles, and, or nanobubbles, and various means to apply a shock wave to the liquid and bubble mixture. Each of these means will be described herein.

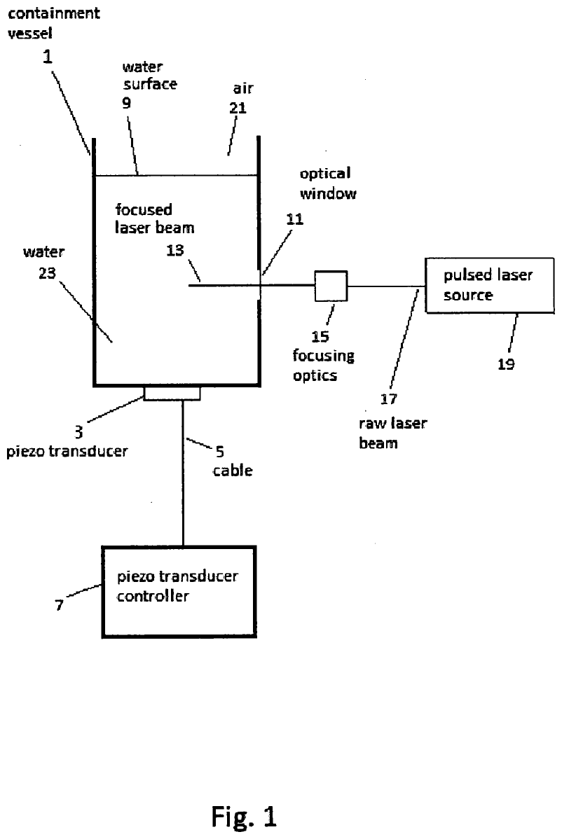

The preferred embodiment may be understood in reference to FIG. 1, where 1 identifies a containment vessel of solid construction which is open to the atmosphere 21 at the top, and which contains a volume 23 of liquid water, or aqueous salt solution, or alternately some other liquid substance, such that an interface surface 9 between air and liquid exists. Cavitation bubbles on the order of microns, and, or nanometers in diameter are created in the liquid volume by acoustic energy that is coupled into the liquid by piezo transducer 3. The piezo transducer is electrically connected by cable 5 to electronic piezo transducer controller 7, which drives the piezo transducer with a pulsed or periodic signal at the frequency and power level appropriate to establish a population of microbubbles, and, or nanobubbles, of the requisite diameter in the volume of liquid 23. A shock wave, or series of sequential shock waves, is created in liquid 23 by means of a pulse from a focused laser beam pulse 13, or which can alternately be created by a sequence of successive pulses. The pulsed laser beam is generated by laser source 19 and focused by focusing optics 15. The laser beam enters the containment vessel through optical window 11, which is transparent at the laser wavelength as fixed by laser source 19. The short intense laser beam pulse creates a plasma at the beam focal region 13 that rapidly expands to generate a shock wave. The shock wave can travel up to a few hundred microns distance in the liquid at a supersonic speed and collides with microbubbles, and, or nanobubbles, that are in its path. EVOs are created from the cavitation “seed” bubbles as the shock wave compresses them and distorts their spherical geometry into toroidal EVOs that may be coherent, meaning that a given particle has motion that is in phase with all other particles.

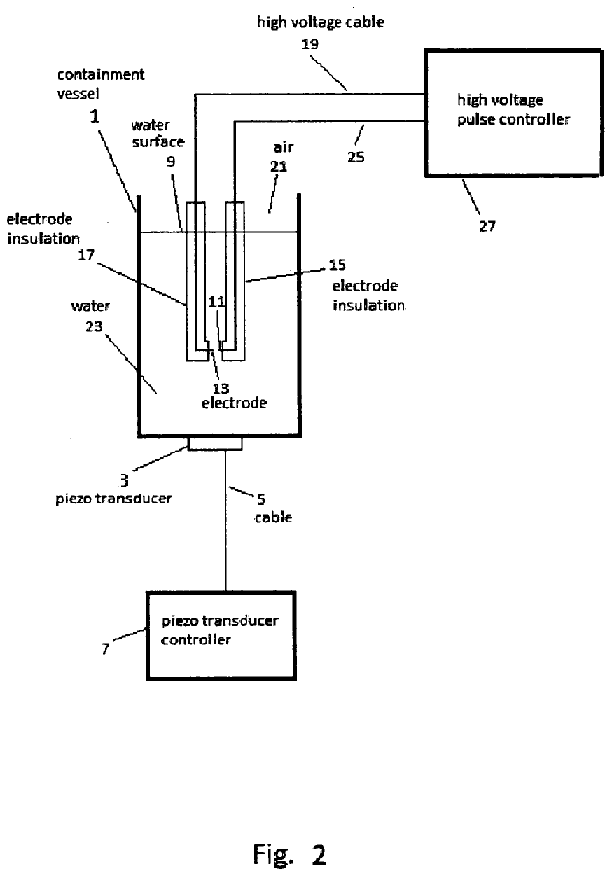

An alternate embodiment is shown in FIG. 2, where 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Cavitation bubbles on the order of microns, and, or nanometers, in diameter are created in the liquid volume by acoustic energy that is coupled into the liquid by piezo transducer 3. The piezo transducer is electrically connected by cable 5 to electronic piezo transducer controller 7, which drives the piezo transducer with a pulsed or periodic signal at the frequency and power level appropriate to establish a population of microbubbles, and, or nanobubbles, of the requisite diameter in the volume of liquid 23. A shock wave, or series of sequential shock waves, is created in liquid 23 by means an electrical arc discharge between submerged electrode ends, 11 and 13. Alternately, a sequence of successive electrical arc discharges may be produced between the electrode ends 11 and 13. Electrode electrical insulation 15 and 17 hermetically seals against electrode contact with the liquid 23, except in the region at the electrode ends 11 and 13. High voltage electrical energy of the appropriately short duration (nanoseconds or less) and voltage magnitude (kilovolts or more) is generated by high voltage pulse controller 27 and electrically connected by high voltage cables 19 and 25 to respective electrodes 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from the cavitation “seed” bubbles as the shock wave compresses them and distorts their spherical geometry into toroidal EVO's that may be coherent, meaning that a given particle has motion that is in phase with all other particles.

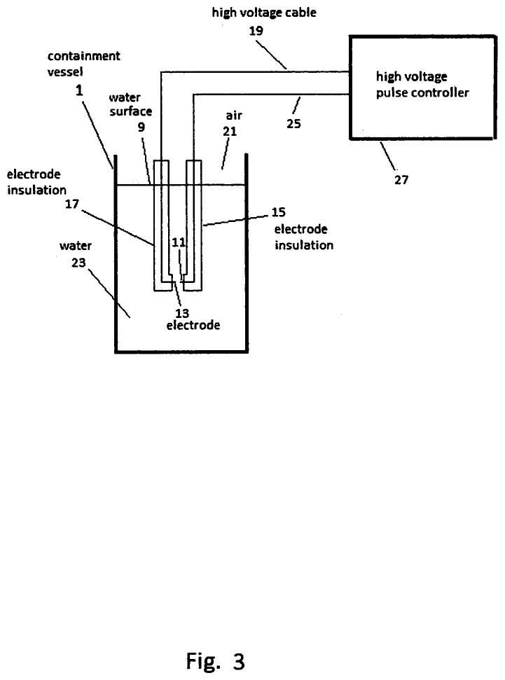

Another embodiment is shown in FIG. 3, where 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Bubbles on the order of microns, and, or nanometers in diameter are created in the region between electrode ends 11 and 13 in the liquid volume 23 by a modest electrical arc discharge of microseconds duration and appropriate electrical potential. The purpose of this arc discharge is to create microbubbles, and, or nanobubbles, as an initial condition which will be immediately followed by a more intense electrical arc discharge that is intended to create a powerful shock wave. Electrode electrical insulation 15 and 17 hermetically seals against electrode contact with the liquid 23, except in the region at the electrode ends 11 and 13. The modest electrical arc discharge is generated by a high voltage pulse controller 27 and electrically connected by high voltage cables 19 and 25 to respective electrodes 11 and 13. A subsequent intense electrical arc discharge of appropriately short duration (nanoseconds or less) and voltage magnitude (kilovolts or more) is generated by a high voltage pulse controller 27 and is electrically connected by high voltage cables 19 and 25 to respective electrodes 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from the “seed” bubbles as the shock wave compresses them and distorts their spherical geometry into toroidal EVOs that may be coherent, meaning that a given particle has motion that is in phase with all other particles.

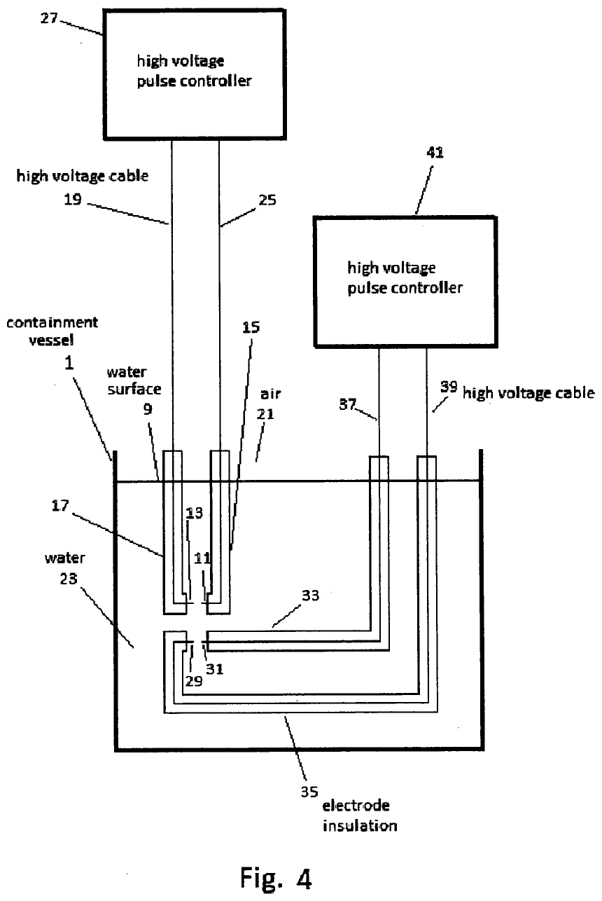

A modification to the embodiment identified in FIG. 3 is shown in FIG. 4. In the embodiment depicted in FIG. 4, a second pair of electrodes having their own dedicated high voltage controller is added. In the embodiment shown in FIG. 4, item 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Electrode electrical insulation 15 and 17, and 33 and 35, hermetically seals against electrode contact with the liquid 23, except in the region at the electrode ends 11 and 13, and 29 and 31, respectively. Bubbles on the order of microns, and, or nanometers in diameter are created in the region between electrode ends 29 and 31 in the liquid volume 23 by a modest electrical arc discharge of microseconds duration and appropriate electrical potential. The purpose of this arc discharge is to create microbubbles, and, or nanobubbles, as an initial condition which will be immediately followed by a more intense electrical arc discharge that is intended to create a powerful shock wave. The modest electrical arc discharge is generated by high voltage pulse controller 41 and electrically connected by high voltage cables 37 and 39 to respective electrodes 29 and 31. Next, an intense electrical arc discharge of appropriately short duration (nanoseconds or less) and voltage magnitude (kilovolts or more) is generated by high voltage pulse controller 27 and electrically connected by high voltage cables 19 and 25 to respective electrodes 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from the “seed” bubbles as the shock wave compresses them and distorts their spherical geometry into toroidal EVOs that may be coherent, meaning that a given particle has motion that is in phase with all other particles.

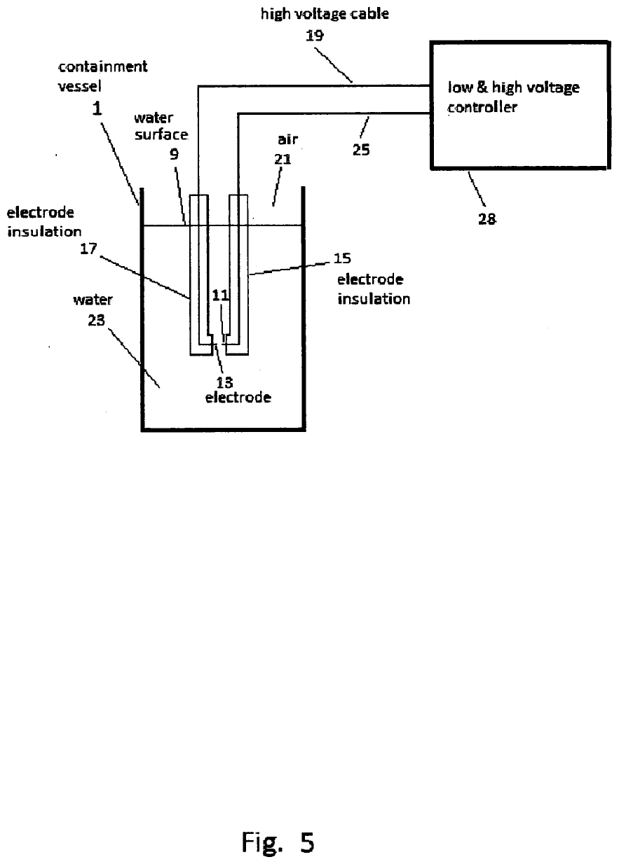

As a different modification to the embodiment identified in FIG. 3, the embodiment of FIG. 5 introduces a single voltage controller 28 capable of producing a relatively lower voltage, as well as a high voltage, but not simultaneously, rather the low then high voltage is established in sequential fashion. The lower voltage is in a suitable form to cause pulsed direct current or pulsed alternating current, and which by having appropriate voltage magnitude and pulse duration causes generation of microbubbles, and, or nanobubbles, in the liquid 23 by electrolysis. The lower voltage pulse is applied as a first step to create microbubbles, and, or nanobubbles, then a high voltage pulse is applied to create a shock wave. In FIG. 5, 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Electrode electrical insulation 15 and 17 hermetically seals against electrode contact with the liquid 23, except in the region at the electrode ends 11 and 13. Electrolysis bubbles on the order of microns, and, or nanometers in diameter are created in the region between electrode ends 11 and 13 in the liquid volume 23 by the lower voltage pulse. The microbubbles, and, or nanobubbles, are created as an initial condition which will be immediately followed by a high voltage pulse to cause an intense electrical arc discharge that is intended to create a powerful shock wave. Electrode electrical insulation 15 and 17 hermetically seals against electrode contact with the liquid 23, except in the region at the electrode ends 11 and 13. The low voltage electrolysis-causing pulse is generated by low- and-high-voltage controller 28 and electrically connected by high voltage cables 19 and 25 to respective electrodes 11 and 13. Next, an intense electrical arc discharge of appropriately short duration (nanoseconds or less) and voltage magnitude (kilovolts or more) is generated by low and high voltage controller 28 and electrically connected by high voltage cables 19 and 25 to respective electrodes 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from these “seed” bubbles as the shock wave compresses them and distorts their spherical geometry into toroidal EVOs that may be coherent, meaning that a given particle has motion that is in phase with all other particles.

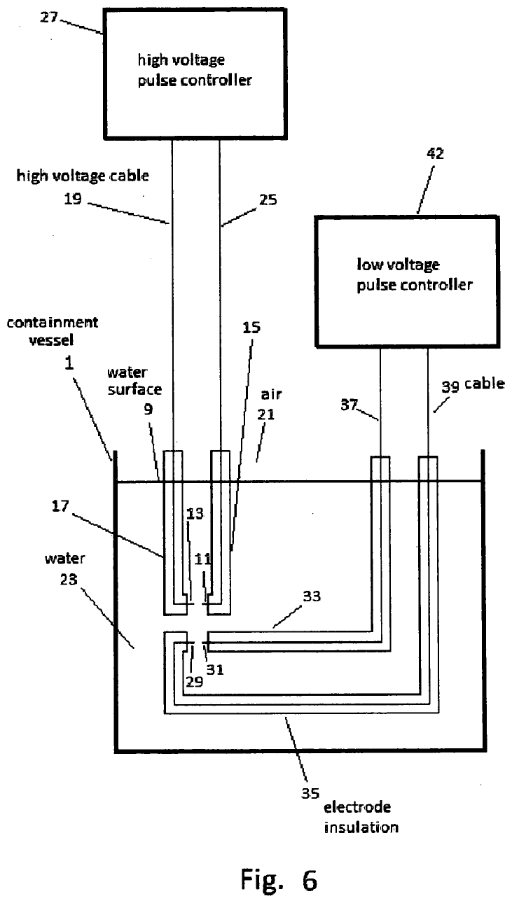

A further embodiment as a modification to the one shown in FIG. 4 is presented in FIG. 6. Here the initial condition microbubbles, and, or nanobubbles, are created by relatively lower voltage electrolysis rather than a high voltage pulse as in FIG. 4. The lower voltage is in a form able to cause pulsed direct current or pulsed alternating current, and which by having appropriate voltage magnitude and pulse duration causes generation of microbubbles, and, or nanobubbles, in the liquid 23 by electrolysis. The lower voltage pulse is applied as a first step to create microbubbles, and, or nanobubbles, then a high voltage pulse is applied to create a shock wave. In the embodiment shown in FIG. 6, item 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. The low voltage electrolysis causing pulse is generated by low voltage pulse controller 42 and electrically connected by cables 37 and 39 to respective electrodes 29 and 31. Electrode electrical insulation 15 and 17, and 33 and 35, hermetically seals against electrode contact with the liquid 23, except in the region at the electrode ends 11 and 13, and 29 and 31, respectively. Electrolysis bubbles on the order of microns, and, or nanometers in diameter are created in the region between electrode ends 29 and 31 in the liquid volume 23 when the low voltage pulse is applied. Next, an intense electrical arc discharge of appropriately short duration (nanoseconds or less) and voltage magnitude (kilovolts or more) is generated by high voltage pulse controller 27 and electrically connected by high voltage cables 19 and 25 to respective electrodes 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from these “seed” bubbles as the shock wave compresses them and distorts their spherical geometry into toroidal EVOs that may be coherent, meaning that a given particle has motion that is in phase with all other particles.

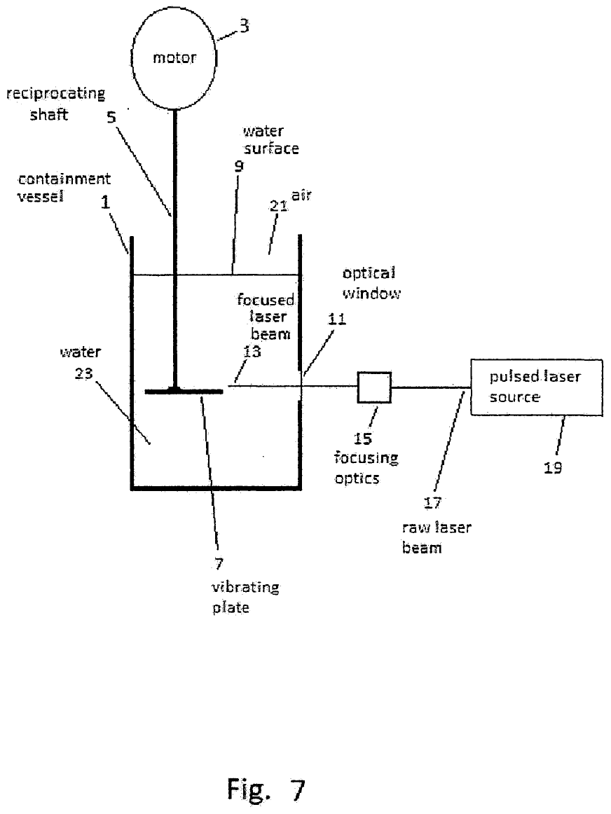

Another embodiment, which is a modification to the one shown in FIG. 1, is represented by FIG. 7. Here, a motor is used to drive a reciprocating shaft that is rigidly affixed to a solid submerged plate. The vibrating plate then causes cavitation bubbles in the liquid. In FIG. 7, item 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Cavitation bubbles on the order of microns, and, or nanometers in diameter are created in the liquid volume by the motor 3 driven reciprocating shaft 5 which is affixed to plate 7 that is submerged in the liquid 23. The mechanical energy of the vibrating plate is of a frequency and magnitude (established by the motor speed) to create the requisite diameter cavitation bubbles. A shock wave, or series of sequential shock waves, is created in liquid 23 by means of a focused laser beam pulse 13, which can alternately comprise a sequence of successive pulses. The pulsed laser beam is generated by laser source 19 and focused by focusing optics 15. The laser beam enters the containment vessel through optical window 11, which is transparent at the laser wavelength as fixed by laser source 19. The short intense laser beam pulse creates a plasma at the beam focal region 13 that rapidly expands to generate a shock wave. The shock wave will travel through the liquid at a supersonic speed and collides with microbubbles, and, or nanobubbles, that are in its path. EVOs are created from the cavitation “seed” bubbles as the shock wave compresses them and distorts their spherical geometry into toroidal EVOs that may be coherent, meaning that a given particle has motion that is in phase with all other particles.

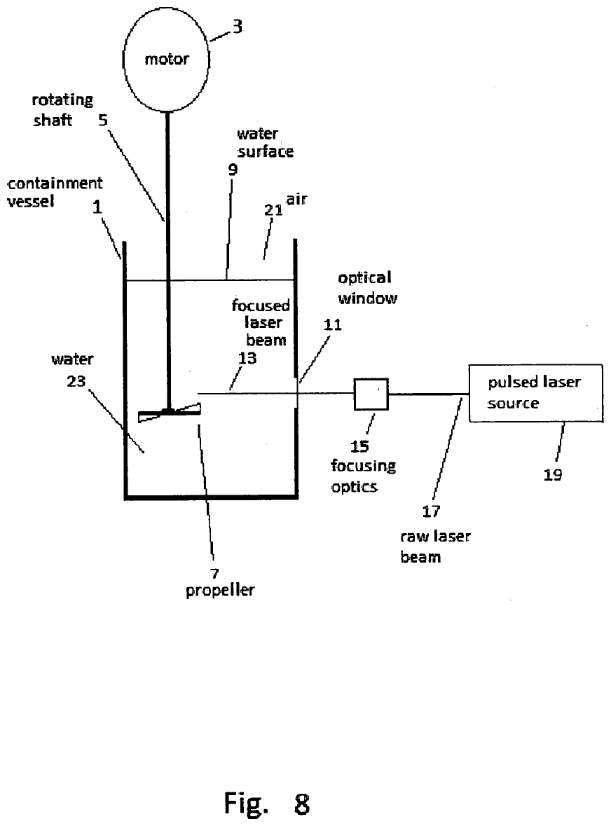

Another embodiment, which is a modification to the one shown in FIG. 7, appears in FIG. 8. Here, a motor is used to drive a rotating shaft that is rigidly affixed to a solid submerged propeller. The rotating propeller then causes cavitation bubbles in the liquid. In FIG. 8, 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Cavitation bubbles on the order of microns, and, or nanometers in diameter are created in the liquid volume by the motor 3 driven rotating shaft 5 which is affixed to propeller 7 that is submerged in the liquid 23. The mechanical energy of the rotating propeller is of a magnitude (established by the motor speed and propeller pitch) to create the requisite diameter cavitation bubbles. A shock wave, or series of sequential shock waves, is created in liquid 23 by means of a focused laser beam pulse 13, which can alternately comprise a sequence of successive pulses. The pulsed laser beam is generated by laser source 19 and focused by focusing optics 15. The laser beam enters the containment vessel through optical window 11, which is transparent at the laser wavelength as fixed by laser source 19. The short intense laser beam pulse creates a plasma at the beam focal region 13 that rapidly expands to generate a shock wave. The shock wave will travel through the liquid at a supersonic speed and collides with microbubbles, and, or nanobubbles, that are in its path. EVOs are created from the cavitation “seed” bubbles as the shock wave compresses them and distorts their spherical geometry into toroidal EVOs that may be coherent, meaning that a given particle has motion that is in phase with all other particles.

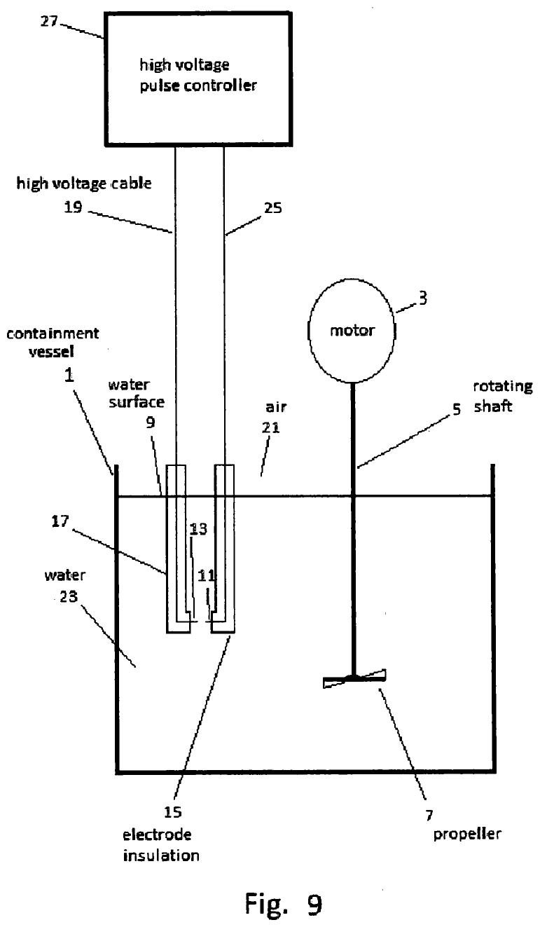

A modification to the embodiment identified in FIG. 8 is shown in FIG. 9. In the embodiment depicted in FIG. 9, a high voltage electrical arc discharge provides the shockwave rather than a laser pulse. In the embodiment shown in FIG. 9, item 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Cavitation bubbles on the order of microns, and, or nanometers in diameter are created in the liquid volume by the motor 3 driven rotating shaft 5 which is affixed to propeller 7 that is submerged in the liquid 23. The mechanical energy of the rotating propeller is of a magnitude (established by the motor speed and propeller pitch) to create the requisite diameter cavitation bubbles. Next, an intense electrical arc discharge of appropriately short duration (nanoseconds or less) and voltage magnitude (kilovolts or more) is generated by high voltage pulse controller 27 and electrically connected by high voltage cables 19 and 25 to respective electrodes 11 and 13. Electrode electrical insulation 15 and 17, hermetically seals against electrode contact with the liquid 23, except in the region at the electrode ends 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from the cavitation “seed” bubbles as the shock wave compresses them and distorts their spherical geometry into toroidal EVOs that may be coherent, meaning that a given particle has motion that is in phase with all other particles.

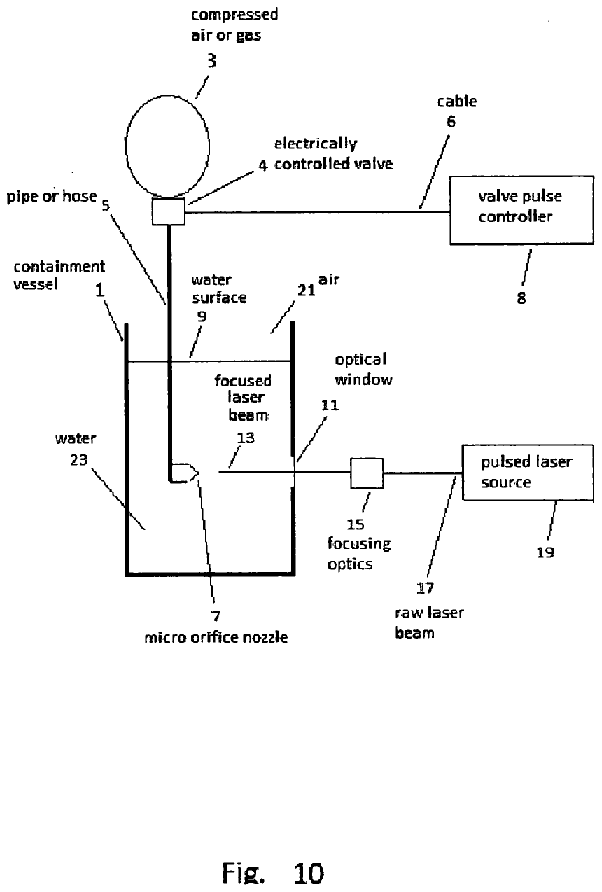

A different modification to the embodiment of FIG. 8 is represented by FIG. 10. Here, a pulse of compressed gas is emitted from a submerged micro-orifice nozzle to establish micro-size gas bubbles in the liquid, rather than cavitation bubbles from a rotating propeller as in FIG. 8. In FIG. 10, 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Bubbles on the order of microns, and, or nanometers in diameter are injected into the liquid volume by means of compressed air or gas, from source 3 traveling through electrically controlled valve 4, and pipe or hose 5, to the submerged micro-orifice nozzle 7. The valve pulse controller 8 sends an electrical signal to electrically controlled valve 4 via cable 6 to open and close the valve at appropriate times. The timing is such that the valve is opened to produce micro-bubbles in the liquid. Next, a shock wave, or series of sequential shock waves, is created in liquid 23 by means of a focused laser beam pulse 13, which can alternately comprise a sequence of successive pulses. The pulsed laser beam is generated by laser source 19 and focused by focusing optics 15. The laser beam enters the containment vessel through optical window 11, which is transparent at the laser wavelength as fixed by laser source 19. The short intense laser beam pulse creates a plasma at the beam focal region 13 that rapidly expands to generate a shock wave. The shock wave will travel through the liquid at a supersonic speed and collides with microbubbles, and, or nanobubbles, that are in its path. EVOs are created from the “seed” bubbles as the shock wave compresses them and distorts their spherical geometry into toroidal EVOs that may be coherent, meaning that a given particle has motion that is in phase with all other particles.

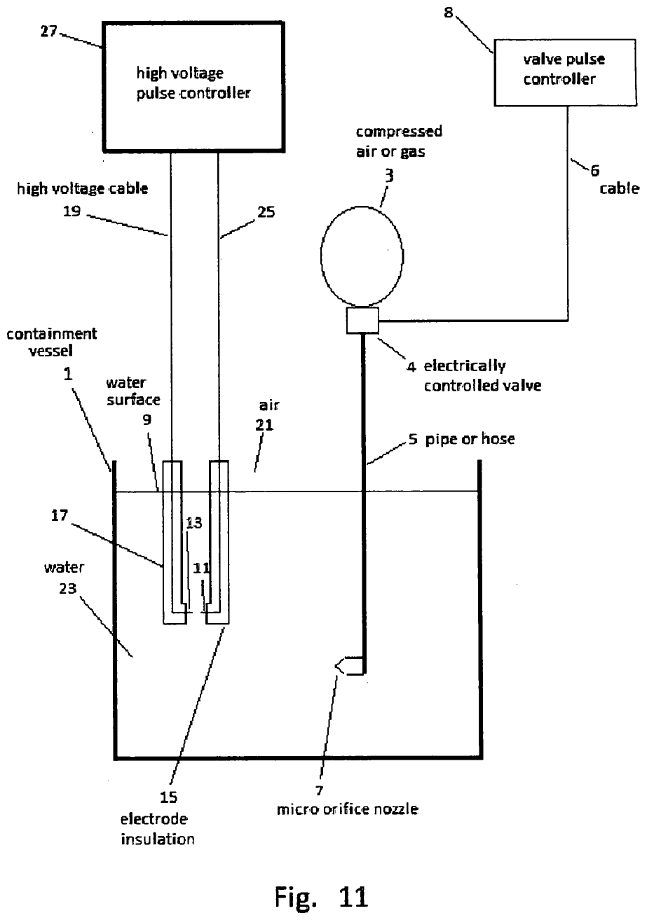

A further modification to the embodiment of FIG. 9 appears in FIG. 11. Here, a pulse of compressed gas is emitted from a submerged micro-orifice nozzle to establish micro-size gas bubbles in the liquid, rather than cavitation bubbles from a rotating propeller as in FIG. 9. However, the electric arc discharge is retained as the means to create a shock wave. In the embodiment shown in FIG. 11, item 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Bubbles on the order of microns, and, or nanometers in diameter are injected into the liquid volume by means of compressed air or gas, from source 3 traveling through electrically controlled valve 4, and pipe or hose 5, to the submerged micro-orifice nozzle 7. The valve pulse controller 8 sends an electrical signal to electrically controlled valve 4 via cable 6 to open and close the valve at appropriate times. The timing is such that the valve is opened to produce micro-bubbles in the liquid. Next, an intense electrical arc discharge of appropriately short duration (nanoseconds or less) and voltage magnitude (kilovolts or more) is generated by high voltage pulse controller 27 and electrically connected by high voltage cables 19 and 25 to respective electrodes 11 and 13. Electrode electrical insulation 15 and 17, hermetically seals against electrode contact with the liquid 23, except in the region at the electrode ends 11 and 13. The short intense electrical arc discharge creates a plasma in the region between electrode ends 11 and 13 that rapidly expands to generate a shock wave. The shock wave will travel through the liquid at a supersonic speed and collides with microbubbles, and, or nanobubbles, that are in its path. EVOs are created from the “seed” bubbles as the shock wave compresses them and distorts their spherical geometry into toroidal EVOs that may be coherent, meaning that a given particle has motion that is in phase with all other particles.

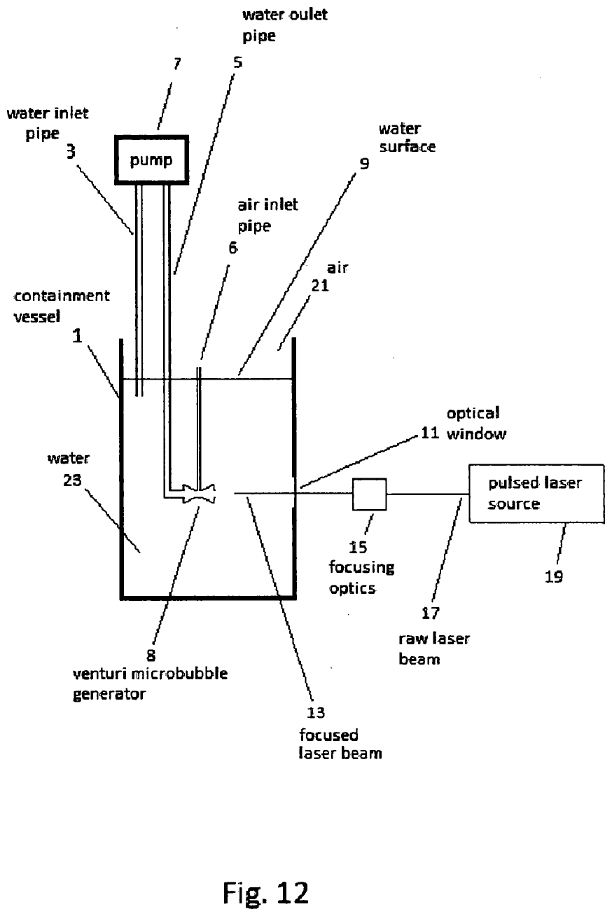

An alteration of the embodiment displayed in FIG. 1 is shown in FIG. 12, where 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Microbubbles, and, or nanobubbles, on the order of microns, and, or nanometers in diameter are created in the liquid volume by an appropriately designed submerged venturi 8, having the liquid 23 sent through the venturi at an established flow rate by pump 7. An advantage of the venturi is that a different gas such as xenon, argon, or pure nitrogen, for example, can be introduced inside the bubble. These bubbles are not cavitation bubbles. The liquid 23 is recirculated inside the containment vessel 1, wherein the liquid enters the water inlet pipe's 3 submerged end and is moved by pump pressure though the water outlet pipe 5 to the venturi 8. The water flows through the venturi 8 and draws air, or some other gas from a source not shown in the Figure, into the venturi through inlet pipe 6, creating a mixture of microbubbles, and, or nanobubbles, and water, that exits the venturi, flowing back into the containment vessel 1. A shock wave, or series of sequential shock waves, is created in liquid 23 by means of a focused laser beam pulse 13, which can alternately comprise a sequence of successive pulses. The pulsed laser beam is generated by laser source 19 and focused by focusing optics 15. The laser beam enters the containment vessel through optical window 11, which is transparent at the laser wavelength as fixed by laser source 19. The short intense laser beam pulse creates a plasma at the beam focal region 13 that rapidly expands to generate a shock wave. The shock wave will travel through the liquid at a supersonic speed and collides with microbubbles, and, or nanobubbles, that are in its path. EVOs are created from the “seed” bubbles as the shock wave compresses them and distorts their spherical geometry into toroidal EVOs that may be coherent, meaning that a given particle has motion that is in phase with all other particles.

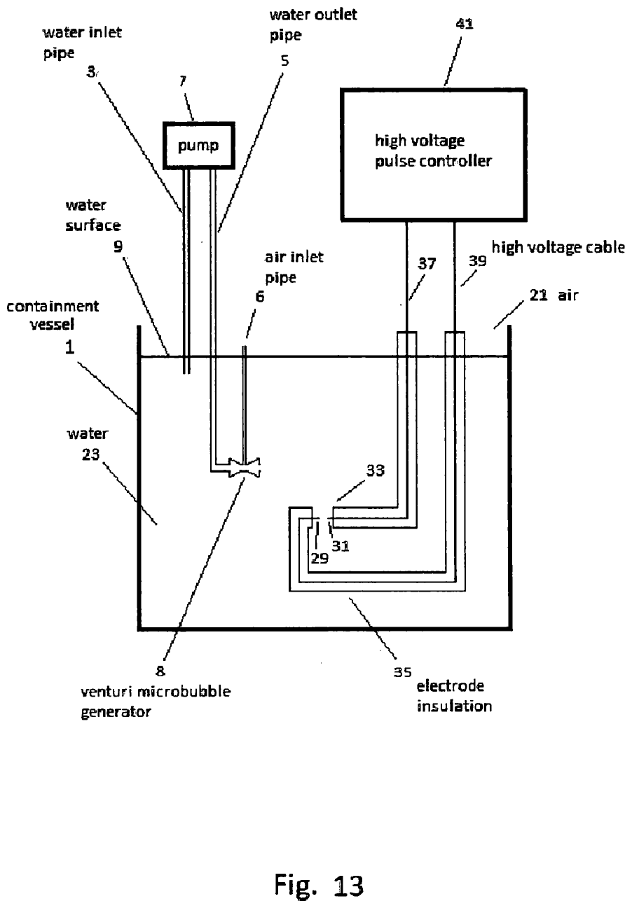

FIG. 13 depicts a modification to FIG. 12, where 1 identifies a solid construction containment vessel which is open to the atmosphere 21 at the top, but which contains a volume 23 of liquid water, or aqueous salt solution, or alternately some other liquid substance, such that an interface surface 9 between air and liquid exists. Microbubbles, and, or nanobubbles, on the order of microns, and, or nanometers in diameter are created in the liquid volume by an appropriately designed submerged venturi 8, having the liquid 23 sent through the venturi at an established flow rate by pump 7. The liquid 23 is recirculated inside the containment vessel 1, wherein the liquid enters the water inlet pipe's 3 submerged end and is moved by pump pressure though the water outlet pipe 5 to the venturi 8. The water flows through the venturi 8 and draws air, or some other gas from a source not shown in the Figure, into the venturi through inlet pipe 6, creating a mixture of microbubbles, and, or nanobubbles, and water that exits the venturi, flowing back into the containment vessel 1. A shock wave, or series of sequential shock waves, is created in liquid 23 by means an electrical arc discharge between submerged electrode ends, 29 and 31. Alternately, a sequence of successive electrical arc discharges may be produced between the electrode ends 29 and 31. Electrode electrical insulation 33 and 35 hermetically seals against electrode contact with the liquid 23, except in the region at the electrode ends 29 and 31. High voltage electrical energy of the appropriately short duration (nanoseconds or less) and voltage magnitude (kilovolts or more) is generated by high voltage pulse controller 41 and electrically connected by high voltage cables 37 and 39 to respective electrodes 29 and 31. The short intense electrical arc discharge creates a plasma in the region between electrode ends 29 and 31 that rapidly expands to generate a shock wave. The shock wave will travel through the liquid at a supersonic speed and collides with microbubbles, and, or nanobubbles, that are in its path. EVOs are created from the “seed” bubbles as the shock wave compresses them and distorts their spherical geometry into toroidal EVOs that may be coherent, meaning that a given particle has motion that is in phase with all other particles.

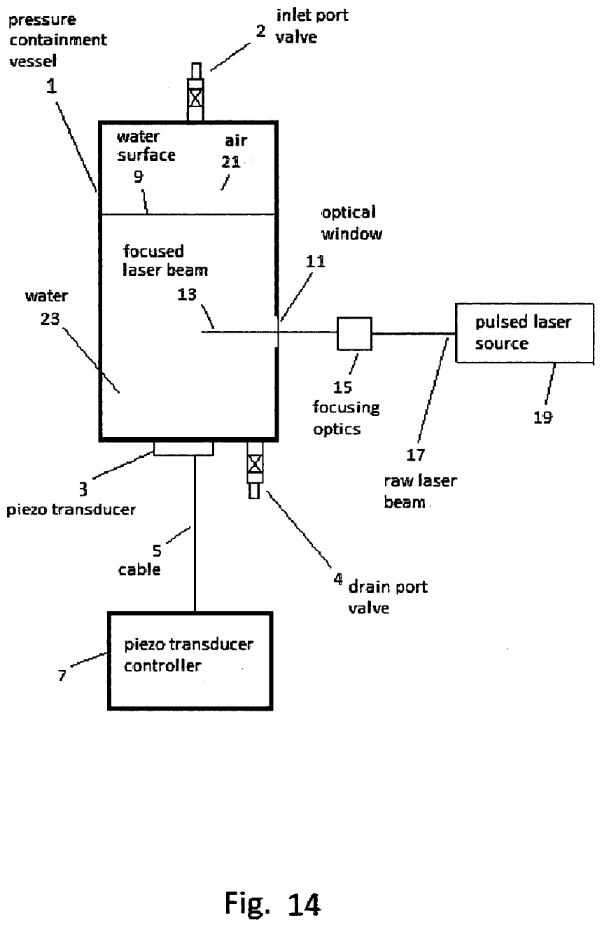

It can be advantageous to permit adjustment of the pressure of operation for the EVO generating devices described herein. An example of a system in which the pressure can ·be maintained at various pressure settings is shown in FIG. 14. This is also a modification to the embodiment that appears in FIG. 1 by employing a closed containment vessel (rather that the open vessel of FIG. 1). In FIG. 14, solid construction pressure containment vessel 1 includes an inlet port valve 2, and a drain port valve 4. Addition or removal of liquids and gases may be accomplished by utilizing the inlet port and or the drain port, respectively. For example, with the drain port valve 4 closed, liquid may be added through inlet port valve 2 to any desired amount. In the case that the vessel is not completely filled up with liquid, but an air (or gas) space 21 is maintained above the liquid surface 9, a vacuum pump may be connected to the inlet port valve 2 and the system pressure reduced to a level below ambient atmospheric pressure, wherein the inlet port valve may then be closed, establishing a fixed but reduced pressure inside the containment vessel 1. Alternatively, the inlet port valve 2 may be left opened to the external atmosphere so that the containment vessel 1 internal pressure is retained at ambient atmospheric pressure. Lastly, a compressed air or gas source may be connected to the opened inlet port valve 2 and the pressure inside the containment vessel 1 may be increased to greater than ambient atmospheric pressure. The inlet port valve 2 may then be closed to maintain this pressure value. In all other aspects, the operation of the embodiment of FIG. 14 is identical to that of the embodiment of FIG. 1.

1. A method of creating exotic vacuum objects (EVOs) in a liquid confined to a container, wherein the method comprises the steps of:
a. establishing an initial concentration of microbubbles, and, or, nanobubbles, in a volume of the liquid and
b. subjecting the liquid containing microbubbles, and, or, nanobubbles, to a shockwave that traverses the liquid volume at supersonic velocity.

2. A method of creating exotic vacuum objects (EVOs) as recited in claim 1 wherein the container is open, containing the liquid at ambient pressure, the method of establishing an initial concentration of microbubbles, and, or, nanobubbles, in a volume of the liquid taken from the group comprising:
a. piezo transducer cavitation,
b. electric arc discharge between electrodes submerged in the liquid,
c. electrolysis,
d. cavitation obtained by motor-driven vibrating plate or plates submerged in the liquid,
e. cavitation obtained by a motor-driven propeller submerged in the liquid,
f. expulsion of compressed gas from a micro orifice nozzle submerged in the liquid, and
g. venturi generation of microbubbles, and, or, nanobubbles
and the method of subjecting the liquid containing microbubbles, and, or, nanobubbles, to a shockwave taken from the group comprising:
a. directing a laser pulse into the liquid volume, and
a. creating an electric arc discharge between electrodes submerged in the liquid volume.

3. A method of creating exotic vacuum objects (EVOs) as recited in claim 1 wherein the container is sealed containing an active fluid that is at a pressure established by a vacuum/pressurization pump or system, the method of establishing an initial concentration of microbubbles, and, or, nanobubbles in a volume of the liquid taken from the group comprising:
a. piezo transducer cavitation,
b. electric arc discharge between electrodes submerged in the liquid,
c. electrolysis,
d. cavitation obtained by motor-driven vibrating plate or plates submerged in the liquid,
e. cavitation obtained by a motor-driven propeller submerged in the liquid,
f. expulsion of compressed gas from a micro orifice nozzle submerged in the liquid, and
g. venturi generation of microbubbles, and, or, nanobubbles
and the method of subjecting the liquid containing microbubbles and, or, nanobubbles, to a shockwave taken from the group comprising:
a. directing a laser pulse into the liquid volume, and
a. creating an electric arc discharge between electrodes submerged in the liquid volume.

4. A method of creating exotic vacuum objects (EVOs) as recited in claim 3 wherein the active fluid is taken from the group comprising:
a. liquid and air,
b. liquid and a gas other than air, and
c. liquid and a gas mixture.

5. A method of creating exotic vacuum objects (EVOs) as recited in claim 4 wherein the container possesses an inlet port valve and a drain port valve to facilitate altering the amount of active fluid enclosed in the container and the pressure inside the container.
